(19) United States
(12) Patent Application Publication
(10) Pub. No.: US 2024/0397978 A1
(43) Pub. Date: Dec. 5, 2024

(54) FOOD COMPOSITION FOR ANIMALS AND METHOD OF PREPARATION THEREOF

(71) Applicant: GENERAL&PHARMA S.R.L., DESENZANO DEL GARDA, BRESCIA (IT)

(72) Inventors: MATTIA SAPORITI, DESENZANO DEL GARDA (IT); MARCO ANDALONI, DESENZANO DEL GARDA (IT)

(21) Appl. No.: 18/698,985

(22) PCT Filed: Nov. 9, 2021
(86) PCT No.: PCT/IB2021/060360

§ 371 Date: Apr. 5, 2024

(30) Foreign Application Priority Data
Oct. 7, 2021 (IT) 102021000025679

(51) Int. Cl. A23K 50/42; A23K 10/20; A23K 10/30; A23K 20/142; A23K 20/174; A23K 20/24

(52) U.S. Cl. CPC A23K 50/42; A23K 10/20; A23K 10/30; A23K 20/142; A23K 20/174; A23K 20/24

(57) ABSTRACT

An instant food composition for animals is reconstitutable by adding water and includes a dehydrated vegetable grain component such that the grains are dehydrated and the outer surface of the grains is at least partially coated with an edible hydrophobic shell, a dehydrated protein component of animal origin, an additional dehydrated vegetable component, and a dehydrated appetizing component. A method for preparing an instant food composition for animals that includes mixing a plurality of dehydrated grains of a vegetable component; during mixing, spraying an edible hydrophobic composition onto the mixture; allowing the composition to deposit on the grains to form an edible hydrophobic shell; further mixing the coated grains with a dehydrated protein component of animal origin, an additional dehydrated vegetable component, a dehydrated appetizing component to obtain the instant food composition for animals.

The invention relates to a food composition for animals, in particular carnivorous mammals, and more in particular pets like cats and dogs, and a method for producing the aforesaid composition.

In the field of the food products that are intended for pets, in particular dogs and cats, wet food products (pâté and chunks, usually packaged in a pouch or can) and dry food products (nuggets, usually packaged in a pouch or box) are known and widely used.

Although the known industrial products offer indisputable advantages, such as for example the fact of being ready for use and convenient to administer, the aforesaid products can nevertheless contain substances like colouring agents, preservatives and additives. Although these substances are tolerable because they are food grade ingredients, they are nevertheless substantially extraneous to the diet and the real nutritional and metabolic needs of the animals.

Another drawback of the known industrial products is the substantially “artificial” nature thereof, whether they be wet or dry products. In fact, by opening a food package for dogs or cats of known type, organoleptic properties (smell, colour) are perceived that are significantly different from those of a food that is prepared directly by the owner of the animal in the kitchen of its own dwelling.

A further drawback of the known industrial products is that the nature thereof of being “ready foods” deprives to a certain extent the owner of dogs or cats of the pleasure of preparing a meal, in particular a hot meal, for his or her pet. This interferes somehow with the empathetic relationship between owner and animal, which is usually manifested through nurturing behaviours such as for example the preparation of meals.

It should nevertheless be noted that the owners of dogs and cats, especially if they are people in working age, have to face not negligible organizational problems, above all problems of time, in managing their animals. In fact, the foods have to be administered to the animals by their owners, often hastily, before the owners leave home to go to work. In other cases, the owners are forced to return home from work, for example during a short lunch break, to feed the animals.

Therefore, the owners of dogs and cats do not always have sufficient time to prepare meals for their animals personally. Thus, although they actually wish to be able to offer “home-made” food to their animals, they are substantially forced to use the known industrial food products.

Among users (owners of dogs and cats) and the skilled persons (manufacturers of pet food, in particular for mammals like dogs and cats) a great need is thus felt for food products for animals that are able to overcome the drawbacks disclosed above.

### OBJECTS OF THE INVENTION

An object of the invention is to improve the food products for pets, in particular for carnivorous mammals such as dogs and cats.

Another object of the invention is to improve the known methods per preparing food products for pets, in particular for carnivorous mammals such as dogs and cats.

A further object is to make available a food product for pets, such as dogs and cats, that enables the owner of a dog or cat to prepare a meal personally, in particular a hot meal, for the animal, avoiding an excessive expenditure of time.

Another further object is to make available a food product for pets, such as dogs and cats, which food product, although being prepared industrially, at the moment of administration exhibits organoleptic properties that are substantially similar to those of a food prepared directly by the owner of the animal.

Yet another object is to make available a food product for pets, in particular for carnivorous mammals such as dogs and cats, that does not contain substances that are extraneous to the nutritional and metabolic needs of the animals, such as colouring agents and/or preservatives.

### SHORT DESCRIPTION OF THE INVENTION

In a first aspect of the invention, an instant food composition for animals is provided, as defined in claim 1.

In a second aspect of the invention, a method is provided for preparing an instant food composition for animals, as defined in claim 20.

Owing to these aspects, the aforementioned objects are achieved, inasmuch as a dry (dehydrated) food composition is made available that is based on dehydrated cereals (puffed rice and/or other cereals that are extruded, flaked or puffed), that comprises a mixture of vegetable and animal ingredients and can be easily and rapidly reconstituted at the moment of use by adding a set volume of lukewarm (about 40° C.) or ambient temperature water, so as to obtain a wet food. In this manner, the owner of a dog or a cat can prepare the meal for his or her animal without an excessive expenditure of time and further receiving a substantial gratification arising from having nurtured the animal personally.

Furthermore, when a package of the food composition according to the invention is opened, the dog or cat owner views dehydrated ingredients, the animal or vegetable origin of which is immediately perceptible (for example, pieces of dried carrot and/or pieces of dried meat) and thus the substantially “natural” character of the food. The formulations of the food composition according to the invention are also free of colouring agents and preservatives.

Once it has been reconstituted with the addition of (lukewarm or at ambient temperature) water, the food composition according to the invention exhibits organoleptic properties that are substantially similar to those of a “home-made” food. Therefore, the food composition according to the invention is absolutely suitable for those who prefer to prepare a hot meal for their animal instead of using the known (dry or wet) food products.

Once it has been reconstituted, the food composition according to the invention becomes an instant soup that can be administered to an animal, for example a dog, as a full meal, supplementary meal, reward meal (for example, for animals undergoing training) or travel meal.

The food composition according to the invention is packaged in a disposable container, manufactured with food-grade material and provided with a peelable lid. The container, which is substantially jar-or glass-shaped, is convenient to handle and thus can easily be used outside the home, for example when travelling. In particular, since the food composition according to the invention is prepared and packaged in dry state, the aforesaid disposable container can be easily kept and carried at ambient temperature.

In order to enable the user to add a quantity of water that is sufficient to reconstitute the dehydrated mixture in an optimum manner, the wall of the container comprises a level indicator (for example, a notch).

The method for preparing the food composition according to the invention comprises a step in which the surface of the cereals is coated with an edible hydrophobic shell. When the food composition is reconstituted with water, this enables the imbibition time (namely the rehydration time) of the cereals comprised in the mixture to be increased. In this manner, the aforesaid cereals are kept crunchy for a longer period, promoting the achievement of a greater volume of rehydrated product and a greater enjoyment of the product by the animal (dog, cat), which it is well known prefers foods that are provided with a crunchy consistency. The edible hydrophobic shell can comprise specific active ingredients, which enable the shelf-life (storage time) of the product and the palatability of the product (appetizing function) to be increased.

### SHORT DESCRIPTION OF THE DRAWINGS

FIG. 1 is a schematic view showing the effect of the water on a dehydrated cereal grain (puffed rice) that is not coated with the edible hydrophobic shell according to the invention.

FIG. 2 is a schematic view showing the effect of the water on a dehydrated cereal grain (puffed rice) that is coated with the edible hydrophobic shell according to the invention.

FIG. 3 is a scatter graph showing the outcomes of an experimental comparison between dehydrated cereal grains (puffed rice) that are coated with the edible hydrophobic shell according to the invention and dehydrated cereal grains (puffed rice) that are not coated with the edible hydrophobic shell according to the invention.

FIG. 4 is a scatter graph showing the outcomes of a further experimental comparison between dehydrated cereal grains (puffed rice) that are coated with the edible hydrophobic shell according to the invention and dehydrated cereal grains (puffed rice) that are not coated with the edible hydrophobic shell according to the invention.

### DETAILED DESCRIPTION OF THE INVENTION

In the context of the present description and of the attached claims:
the terms “food”, “food product” and “food composition” are considered to be synonyms and can be used in a reciprocally interchangeable manner;
the terms “food for animals”, “food product for animals”, “food composition for animals” and “feed” are considered to be synonyms and can be used in a reciprocally interchangeable manner;
the terms “instant” and “reconstitutable” are considered to be synonyms and can be used in a reciprocally interchangeable manner with reference to foods, food products and food compositions, in particular for for animals;
the term “appetizing component” defines a substance, or mixture of substances, that can be added to a food or food product or food composition for animals in order to increase the desirability thereof, both at the primary level, namely before consumption, by improvement of the olfactory and sensorial profile to the nose of the animal, and at the secondary level, namely during swallowing;
the terms “grain” and “grains” define the seeds of cereals and the seeds of plants other than cereals, in particular quinoa and buckwheat.

The Applicant has above all identified in the cereals—in particular in the dehydrated cereals—a food ingredient that is suitable for use as a base matrix of the food composition according to the invention (instant soup for pets). The dehydrated cereals can be prepared using known methods and apparatuses and comprise puffed cereals, extruded cereals, flaked cereals and mixtures thereof.

In general, cereals are foods that are craved for by the animals, they are rich in starch and thus highly energetic, as well as low in proteins. Cereals can also be a source of vitamins, such as vitamin B1 and vitamin B3 (wheat; barley), as well as pigments (carotenoids in yellow maize). The cereals are administered directly to the animals or in feeds that are obtained by mixing various ingredients.

In particular, the Applicant has studied the possibility of using the puffed cereals, which enable food products to be obtained that are light, easily digestible, with a limited caloric supply, with high fibre content and without additives (such as preservatives and colouring agents). The puffed cereal acquires particular organoleptic properties that enhance the fragrance and palatability (pleasantness to the taste). The known method for obtaining puffed cereals comprises selecting the grains of the cereal, toasting the selected grains by dry cooking and then puffing the toasted grains by steam at high pressure and temperature. This procedure enables the cereal to maintain the original shape thereof, whilst increasing volume, and thus enables the cereal to be immediately recognizable by the user.

Cereals in grains that can be easily puffed and extruded and are thus suitably usable as a raw material for the food product according to the invention comprise, for example, rice, spelt, oats, maize, millet, sorghum, rye, triticale (x Triticosecale; a hybrid between rye and plants of the Triticum genus).

In addition to the aforementioned cereals, quinoa (belonging to the Chenopodiaceae family) and buckwheat (belonging to the Polygonaceae family) are plants whose seeds (grains) can be easily dehydrated and are thus usable suitably as a dehydrated raw material for the food product according to the invention.

The dehydrated grains of quinoa and buckwheat comprise puffed, extruded or flaked grains of quinoa and buckwheat.

A possible drawback connected to the use of dehydrated (puffed, extruded or flaked) cereals, quinoa and/or buckwheat, is the significant hygroscopicity thereof, which is due to the starch and fibre content.

For example, if an amount of puffed rice is put in contact with water at ambient temperature and mixed with moderate agitation, due to a simple imbibition process the mixture is transformed into a mush in just a few minutes. In fact, the starch and the fibres of the puffed rice absorb the available water very rapidly. This effect is accelerated if the amount of puffed rice is mixed with hot water.

The composition and the method according to the invention nevertheless enable the drawback described above to be overcome inasmuch as the dehydrated, for example puffed, cereal, are coated with an edible hydrophobic shell or envelope. The edible hydrophobic shell can be made appetizing, namely enriched with appetizing substances.

The edible hydrophobic shell according to the invention is produced by solidifying a corresponding edible hydrophobic composition and, after hydrating the food product according to the invention with lukewarm water, it enables a soup for dogs and cats having a superior organoleptic profile to be obtained. The qualitative and quantitative formulation of the edible hydrophobic composition is reported in the following Table 1:

TABLE 1

| Range % | |
|---|---|
| by weight | Ingredients |
| 90-99.2 | Oil component |
| 0.5-5 | Thickening component |
| 0.1-3 | Dehydrated appetizing component |
| 0.1-1 | Emulsifying component |
| 0.1-1 | Liposoluble antioxidant component |

The oil component comprises oil of vegetable origin and/or oil of animal origin.

The oil component performs the following functions:
lipophilic matrix of the shell; vehicle for the antioxidant system; thickener;
supply of important fatty acids, such as for example EPA (eicosapentaenoic acid), DHA (docosahexaenoic acid) and GLA (γ-linolenic acid);
additional energy supply;
appetizing action, mainly due to the oils of animal origin.

The oils of vegetable origin can comprise, but are not limited to, sunflower seed oil, maize germ oil, coconut oil, soya oil, currant oil, walnut oil, hemp oil, evening primrose oil, borage oil.

Oils of animal origin can comprise, but are not limited to, krill oil, fish oil, salmon oil, insect oil.

The thickening component comprises monoglycerides, diglycerides and triglycerides of fatty acids of vegetable origin and/or magnesium stearate and/or glyceryl stearate and/or vegetable waxes and/or butter of vegetable origin and/or animal fats.

The thickening component performs the following functions:
thickening action;
increase of the resistance to high temperatures;
non-stick action;
shielding action against water penetration.

The vegetable waxes can comprise, but are not limited to, Carnauba wax, Copaiba wax, Candelilla wax.

The butter of vegetable origin can comprise, but is not limited to, soya butter, shea butter, rapeseed oil.

The animal fats can comprise, but are not limited to, chicken fat, pig fat, insect waxes.

It should be noted that the lipids having thickening action and with a melting point >30° C. enable a mixture to be obtained that is in the solid state at ambient temperature. The melting points of lipids comprised in the thickening component are reported in the following Table 2:

TABLE 2

| Lipid | Melting point | |
|---|---|---|
| Candellila wax | 68-73° | C. |
| Rapeseed oil | 36-39° | C. |
| Mono- and diglycerides | 60° | C. |
| of fatty acids (from palm) | | |
| Shea butter | 28-45° | C. |
| Glyceryl stearate | 56-62° | C. |
| Cocoa butter | >32° | C. |

The term “dehydrated appetizing component” defines a mixture of dehydrated yeasts and/or hydrolyzed animal proteins of poultry origin and/or synthetic flavouring molecules. The appetizing component enables the desirability of the food composition according to the invention to be improved.

The mixture of dehydrated yeasts can comprise the following species and genera: Saccharomyces cerevisiae, Saccharomyces carlsbergensis, Kluyveromyces lactis, Kluyveromyces fragilis, Torulaspora delbrueckii, Cyberlindnera jadinii, Saccharomyces uvarum, Saccharomyces ludwigii or Brettanomyces ssp. In one embodiment, the mixture consists of two or more of the aforesaid species and genera. In one embodiment, the mixture of dehydrated yeasts comprises in particular the species Saccharomyces cerevisiae and Kluyveromyces fragilis.

The synthetic flavouring molecules can comprise: vanillin, 2-furanmethanthiol, 2-methylfuran-3-thiol, 3-(methylthio) propionaldehyde, sodium pyrophosphate.

In one embodiment, the edible hydrophobic composition, and consequently the edible hydrophobic shell obtainable therefrom, do not contain the appetizing component and the latter is replaced by a corresponding percentage quantity by weight of an oil component.

The term “emulsifying component” defines an emulsifying agent incorporated into the composition of the edible hydrophobic shell. The emulsifying agent comprises soya lecithin.

The term “liposoluble antioxidant component” defines a mixture of tocopherols and/or rosemary extracts that performs a dual antioxidant action, both in favour of the oil component, and in favour of the other ingredients of the food composition according to the invention.

The qualitative and quantitative composition of the food composition according to the invention, also comprising the lipid hydrophobic shell, is shown in Table 3 below:

TABLE 3

| Range % | |
|---|---|
| in weight | Ingredients |
| 68-97.9 | Dehydrated vegetable component |
| | (grains of cereals and/or quinoa |
| | and/or buckwheat that are |
| | dehydrated and provided |
| | with edible hydrophobic shell) |
| 1-14 | Dehydrated protein component |
| | of animal origin |
| 1-14 | Additional dehydrated vegetable |
| | component (other than |
| | cereals, quinoa and buckwheat) |
| 0.1-5 | Dehydrated appetizing component |

The dehydrated protein component of animal origin comprises, but is not limited to, flours of animal origin, dried or freeze-dried products of animal origin, dehydrated meat (for example freeze-dried meat).

The additional dehydrated vegetable component is other than cereals, quinoa and buckwheat and comprises pieces of dried vegetable and fruit and optionally freeze-dried vegetables (in powder and/or in pieces).

The dehydrated appetizing component has the same composition as the dehydrated appetizing component of the lipid hydrophobic shell (see Table 1).

If the aforementioned embodiment of the edible hydrophobic composition not containing the appetizing component is used and a lipid hydrophobic shell is then produced that is free of appetizing component, the appetizing component can be incorporated in the form of powder into the food composition according to the invention.

In one embodiment, the food composition according to the invention also comprises a functional component and has the qualitative and quantitative formulation reported in Table 4 below:

TABLE 4

| Range % | |
|---|---|
| in weight | Ingredients |
| 63-97.8 | Dehydrated vegetable component (grains of cereals and/or |
| | quinoa and/or buckwheat that are dehydrated and provided |
| | with edible hydrophobic shell) |
| 1-14 | Dehydrated protein component of animal origin |
| 1-14 | Additional dehydrated vegetable component (other than |
| | cereals, quinoa and buckwheat) |
| 0.1-5 | Dehydrated appetizing component |
| 0.1-5 | Functional component |

The functional component can comprise multiple substances that vary on the basis of the purposes of the functionalized food composition that it is desired to produce. Examples 7-12 disclosed below illustrate some functionalized food compositions according to the invention. The dehydrated vegetable component, the dehydrated protein component of animal origin, the additional dehydrated vegetable component and the dehydrated appetizing component are the same as disclosed with reference to Table 3.

In one embodiment, it is possible to prepare vegan formulations using sunflower seed oil as a single oil component of the edible hydrophobic shell and using appetizing substances of vegetable origin.

In another embodiment, thickeners of known type can be added in order to modulate the final viscosity profile of the food composition. This promotes the consumption of the food composition, especially by cat, which animal requires a consistency of foods that is fluid but textured (similar to sauce). For example, xanthan gum and guar gum can be used as suitable thickeners.

In further embodiments, by modulating suitably the dehydrated ingredients and/or the components of the edible hydrophobic shell, a number of types of products can be developed. In particular, by modifying the composition of the oils of the edible hydrophobic shell, products can be developed for the nutritional management of vitamin deficiency states, intestinal and/or skin problems and other situations in which a specific food supplement is necessary.

The method according to the invention, namely the method for preparing an instant food composition for animals, is disclosed below.

The composition of Table 1 is prepared, which will form the edible hydrophobic shell. After weighing the single ingredients, the thickening component is dispersed at a temperature comprised between 40° C. and 50° C. in the oil component and then the dehydrated appetizing component, the emulsifying component and the liposoluble antioxidant component are added by mixing. All the components are mixed reciprocally until a homogeneous mixture is obtained, namely an edible hydrophobic composition. The aforesaid mixing can be carried out in a planetary mixer of known type.

The cereals and/or the quinoa and/or the buckwheat, which are dehydrated, namely extruded, puffed or flaked, are inserted inside a 4-way mixer for powders of known type (for example, a Viani 4VE/007 model mixer or a Viani ST300 model kneader or a Nicomac SWC model coater).

Cereals, quinoa and/or buckwheat can be extruded, puffed or reduced into flakes by methods and apparatuses that are known to the person skilled in the art and that therefore are not disclosed here.

After starting to mix dehydrated cereals and/or quinoa and/or buckwheat, the edible hydrophobic composition is sprayed at a temperature of 40° C. onto the dry mass under stirring through an apparatus of known type (for example, a Viani turret nebulizer). In this manner, the edible hydrophobic composition is deposited on the surface of the dehydrated cereals and/or quinoa and/or buckwheat.

The thickening component (containing lipids with a melting point >30° C.) enables a mixture to be obtained that is in solid state at ambient temperature. Therefore, after the edible hydrophobic composition has been hot sprayed onto the surface of cereals and/or quinoa and/or buckwheat, whilst cereals and/or quinoa and/or buckwheat are maintained under continuous stirring, the aforesaid composition cools to ambient temperature and forms an edible hydrophobic shell, i.e. a solid (hydrophobic edible) layer, having a thickness of just a few μm, in particular a thickness comprised between 20 μm and 500 μm. In one embodiment, the thickness of the edible hydrophobic shell is comprised between 20 μm and 200 μm.

It should be noted that the edible hydrophobic composition is deposited in a substantially inhomogeneous manner on the surface of cereals, quinoa and/or buckwheat, so that completely coated grains and partially coated grains will be obtained.

This enables grains to be obtained that will absorb at different times the water that is added inside a same mixture, thus providing the soup with a creamy consistency through the effect of a partial imbibition of the grains, and at the same time maintaining the grains crunchy because they are substantially (at least partially) impermeable to water.

Once the dehydrated (extruded or puffed or flaked) and provided with the edible hydrophobic shell grains of cereals, quinoa and/or buckwheat are obtained, set quantities of this dehydrated material are placed in suitable containers together with other set quantities of further nutritional and functional ingredients. These further nutritional and functional ingredients are mixed with the dehydrated grains of cereals, quinoa and/or buckwheat and correspond to the components previously disclosed with reference to Table 3 and Table 4. In one embodiment, the (dehydrated and provided with edible hydrophobic shell) grains of cereals, quinoa and/or buckwheat can be mixed with flours of cereal, quinoa and/or buckwheat.

Each container is manufactured from polypropylene (PP) or another suitable food grade material (for example, paper), is jar-or glass-shaped and has a maximum volume of 1000 ml. In other embodiments, the container can have a shape and/or a maximum volume that are different from those disclosed above.

In the embodiment in which the container has a maximum volume of 1000 ml, a quantity of dehydrated product, namely of food composition according to the invention, comprised between 20 and 250 grams can be inserted into the container. The filling of the container can be performed by using methods and apparatuses that are known to the person skilled in the art.

Once the dehydrated food product is inserted into the container, the latter can be closed by applying a peelable (for example, heat-sealed) closure film of known type and/or a pressure cap of known type. Both the film and the cap can be manufactured by using PP or PVC (polyvinyl chloride) or another suitable food grade material and can be applied using methods and apparatuses that are known to the person skilled in the art.

At the time of use, the end user opens the package, by removing the peelable film and/or the pressure cap, and pours a predefined volume of water at ambient or lukewarm temperature (about 40° C.) inside the container. The volume of water to be added varies according to the quantity of dry product and is indicated by a level indicator, for example a notch made in the inner wall of the container and visible to the user after the latter has opened the container.

In one embodiment, the level indicator is positioned on the outer wall of the container. In another embodiment, the level indicator is located on both the inner wall and the outer wall of the container.

After reconstituting with water the food composition according to the invention and after possibly briefly mixing the reconstituted food composition using a spoon, the owner of a pet, in particular the owner of a dog or a cat, can pour the so obtained soup into the bowl of the animal and administer the soup to the animal.

The mode for preparing the instant soup from the composition according to the invention is particularly rapid and convenient, thus enabling the instant soup to be used effectively even when travelling.

On the basis of what has been disclosed above, in the method according to the invention the following steps are identifiable:
mixing a plurality of dehydrated (extruded, puffed or flaked) grains of a vegetable component that is selected from the group consisting of cereals, quinoa, buckwheat and mixtures thereof, so as to obtain a mixture of grains;
during mixing, spraying onto the mixture an edible hydrophobic composition at the temperature of 40° C.;
allowing the edible hydrophobic composition to deposit on an outer surface of the grains;
allowing the deposited hydrophobic composition to cool down until it reaches the ambient temperature and solidify on said outer surface of the grains, so as to form an edible hydrophobic shell which at least partially coats the grains;
mixing the grains that are coated with the edible hydrophobic shell with a dehydrated protein component of animal origin, a dehydrated vegetable component, a dehydrated appetizing component and optionally a functional component, so as to obtain an instant food composition for animals (to be reconstituted with water at the time of use).

The method according to the invention enables a food composition for pets to be produced that is provided with a plurality of advantageous technical effects: increase in imbibition time; maintenance of crunchiness (in particular, in the case of the puffed rice); non-stick action; increase in shelf-life; increase in the exposed surface after reconstitution with water and in desirability; increase in apparent volume.

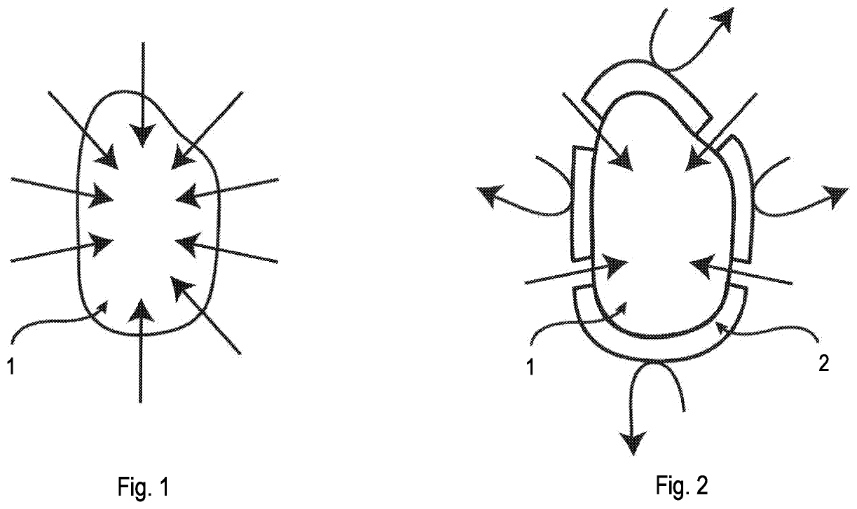

With regard to the imbibition time, it is observed that if grains of puffed rice or of other puffed cereal free of the edible hydrophobic shell disclosed above are put in contact with water or with watery mixtures, the water is immediately absorbed by the grains (high hygroscopicity). This is shown schematically in FIG. 1, in which the water (represented by a plurality of rectilinear arrows) penetrates rapidly inside the grain of rice 1. In fact, fibres and starches in anhydrous state that are present on the outer surface of the grains are directly exposed to the available water and absorb the latter immediately. Consequently, the water imbibed grains rapidly form a mush.

On the contrary, as shown schematically in FIG. 2, if the entire outer surface or part of the outer surface of the grain of rice 1 is coated with the edible hydrophobic shell 2 the passage of part of the water by gradient is initially blocked (the blocked water is represented by a plurality of curved arrows), or anyway slowed, and only after a certain period of time has elapsed the grain of rice 1 is completely imbibed. Therefore, for the same volume of added water and quantity of rice put in contact with the water, the use of dehydrated grains of rice or of another cereal coated with the edible hydrophobic shell according to the invention enables the cereal to be maintained crunchy for a longer time.

A direct consequence of the increase in imbibition time is thus the maintenance of crunchiness of the food composition also after the reconstitution with water. Being it known that the dog and the cat prefer and enjoy chewing portions of food, maintaining a certain degree of crunchiness (within 5-10 minutes of the reconstitution of the food composition according to the invention) enables a product to be offered that is more pleasant and nearer the ethological needs of the animal.

With regard to the non-stick action, it is observed that the edible hydrophobic shell, which envelops partially or totally the dehydrated grains of cercal (or quinoa or buckwheat), prevents the grains from sticking to one another also after imbibition with water. This occurs until starch and fibres are completely imbibed and the grains are physically destroyed by crumbling.

With regard to the increase in shelf-life, it is observed that, by exposing dehydrated (or puffed or extruded or flaked) grains of rice and other cereals to even normal ambient humidity values, the grains soften because the hygroscopic outer surface thereof is able to absorb the humidity of the air. Accordingly, grains of rice left exposed to the ambient air can take on a soft consistency and form aggregates. It is further possible that moulds develop on the grains and that the organoleptic properties of the cereals alter.

On the other hand, the edible hydrophobic shell (obtainable through the method according to the invention) performs a shielding action against ambient humidity, preserving the organoleptic properties of the grains disclosed above. It is thus possible to fill the containers with the food composition according to the invention without the need to use a modified atmosphere.

It should be noted that the lipophilic antioxidant component comprised in the edible hydrophobic shell is able to protect the lipid component of the shell from phenomena of oxidation and rancidification, maintaining at the same time the hygroscopicity of the cereals, which is necessary for reconstituting the product with water. Furthermore, by considering the closed container of the food composition according to the invention as a closed system, the lipophilic antioxidant component, when put in contact with the other ingredients of the food composition according to the invention (for example, animal proteins and vegetable component), is able to exert a certain degree of antioxidant activity also against the aforesaid ingredients.

With regard to the increase in the exposed surface after reconstitution with water and in desirability, it is observed that the method according to the invention enables an end product to be obtained, namely a food product that is reconstituted with water, exhibiting organoleptic properties that are different from that of a simple cereal that is dehydrated and to which other vegetable or animal ingredients have been added.

In particular, the decreased imbibition over time enables to increase the surface of the rice grains that is exposed to the olfaction of the animal. Given the presence of the appetizing component in the edible hydrophobic shell, the exposure of the appetizing molecules to the olfactory receptors of the animal is consequently increased exponentially, which makes the food composition according to the invention particularly appetizing.

With regard to the increase in apparent volume, it is observed that the shape of the dehydrated grain of cereal is maintained intact for a longer period of time after hydration. Maintaining the integrity of the granules after the contact with the water generates an aesthetic advantage for the owner of the animal and a greater volume of product for the same weight of dehydrated cereal.

The Applicant has carried out comparative experimental tests, in which some properties (humidity and viscosity) of a non-treated (namely, not treated with the method according to the invention) puffed rice and of a puffed rice treated with the method according to the invention have been compared. The aforesaid tests are disclosed in detail in Examples 13 and 14.

By way of non-limiting example, the following Examples are disclosed: non-functionalised formulations of the food composition according to the invention (Examples 1-6); functionalized formulations of the food composition according to the invention (Examples 7-12); measurement of the humidity % in samples of non-treated puffed rice and puffed rice treated with the method according to the invention (Example 13); measurement of the viscosity profile in samples of non-treated puffed rice and puffed rice treated with the method according to the invention (Example 14).

### Example 1—“Beef/Rice/Carrots” Formulation

Puffed rice with edible hydrophobic shell 74-93%, dried beef flour 4-14%, dried flaked carrots 1-4%, mixture of powdered vegetables 1-4%, appetizing agent of animal origin (hydrolyzed chicken proteins) 1-4%

### Example 2—“Salmon/Rice/Carrots” Formulation

Puffed rice with edible hydrophobic shell 74-93%, dried salmon flour 4-14%, dried flaked carrots 1-4%, mixture of powdered vegetables 1-4%, appetizing agent of animal origin (hydrolyzed chicken proteins) 1-4%.

### Example 3—“Chicken/Rice/Peas/Carrots” Formulation

Puffed rice with edible hydrophobic shell 70-92%, dried chicken flour 4-14%, dried flaked carrots 1-4%, dried peas 1-4%, mixture of powdered vegetables 1-4%, appetizing agent of animal origin (hydrolyzed chicken proteins) 1-4%.

### Example 4—“Beef/Quinoa/Carrots” Formulation

Puffed quinoa with edible hydrophobic shell 74-93%, dried beef flour 4-14%, dried flaked carrots 1-4%, mixture of powdered vegetables 1-4%, appetizing agent of animal origin (hydrolyzed chicken proteins) 1-4%.

### Example 5—“Duck/Rice/Peas/Carrots” Formulation

Puffed rice with edible hydrophobic shell 70-92%, dried duck flour 4-14%, dried flaked carrots 1-4%, dried peas 1-4%, mixture of powdered vegetables 1-4%, appetizing agent of animal origin (hydrolyzed chicken proteins) 1-4%.

### Example 6—“Apple/Oat/Chicken” Formulation

Oat flakes with edible hydrophobic shell 74-93%, dried chicken flour 4-14%, dried apple in pieces 1-4%, mixture of powdered vegetables 1-4%, appetizing agent of animal origin (hydrolyzed chicken proteins) 1-4%.

### Example 7—Functionalized Formulation for Joints, Osteoarthritis and Joint Pains

The edible hydrophobic shell comprises in particular: fish oil titred in Omega-3 (EPA-DHA), salmon oil, astaxanthin (antioxidant) from algae of the Haematococcus genus, krill oil.

In addition to the dehydrated ingredients of Table 2 and/or of the formulations of Examples 1-7, the functionalized formulation contains: manganese, vegetable extracts with favourable action on joint structures (for example, extracts of Boswellia serrata, willow, turmeric), hyaluronic chondroitin acid, sulphate, glucosamine, collagen, methylsulfonylmethane (MSM), vitamin complex (vitamin C and vitamin D).

### Example 8—Functionalized Formulation for Dermatitises, Dermatoses, Skin and Hair Care

The edible hydrophobic shell comprises in particular: fish oil titred in Omega-3 (EPA-DHA), borage oil, evening primrose oil, currant oil titred in γ-linolenic acid.

In addition to the dehydrated ingredients of Table 2 and/or of the formulations of Examples 1-7, the functionalized formulation contains: zinc, copper, pantothenic acid (vitamin B5), methionine, vitamin complex (folic acid, niacin, biotin).

### Example 9—Functionalized Formulation for Puppy Growth

The edible hydrophobic shell comprises in particular: fish oil titred in Omega-3 (EPA-DHA), liposoluble vitamins (vitamin D3).

In addition to the dehydrated ingredients of Table 2 and/or of the formulations of Examples 1-7, the functionalized formulation contains: calcium, chondroitin sulphate, glucosamine, vitamin complex (vitamins A, B1, B2, B3, B5, B6, B9, B12, biotin, vitamin D, vitamin C) and amino acids (taurine).

### Example 10—Functionalized Energizing Formulation

The edible hydrophobic shell comprises in particular: fish oil titred in Omega-3 (EPA-DHA), coconut oil.

In addition to the dehydrated ingredients of Table 2 and/or of the formulations of Examples 1-7, the functionalized formulation contains magnesium, complex vitamins (vitamins B1, B2, B3, B5, B6, B9, and B12) and amino acids (taurine).

### Example 11—Functionalized “Senior Care” Formulation (for Elderly Animals)

The edible hydrophobic shell comprises in particular: fish oil titred in Omega-3 (EPA-DHA), liposoluble vitamins (vitamin D3).

In addition to the dehydrated ingredients of Table 2 and/or of the formulations of Examples 1-7, the functionalized formulation contains vitamin complex (vitamin D, vitamin C, vitamins B1, B2, B5, B6, B12) and vegetable extracts with favourable action on cognitive skills (for example, extracts of Ginkgo biloba, blueberry).

### Example 12—Functionalized Formulation for Diarrhoea, Intestinal System

The edible hydrophobic shell comprises in particular salmon oil.

In addition to the dehydrated ingredients of Table 2 and/or of the formulations of Examples 1-7, the functionalized formulation contains mineral salts (sodium and potassium) and adsorbents (pectin, bentonite).

### Example 13—Measurement of Humidity % in Samples of Non-Treated Puffed Rice and of Puffed Rice Treated with the Method According to the Invention

Samples were tested of puffed rice treated with the method according to the invention, named hereinafter as “sample puffed rice”, and samples of puffed rice not treated with the method according to the invention, named hereinafter as “reference puffed rice”.

A first mixture was prepared, named as “mixture A”, by mixing 250 ml of drinking water at a temperature of 40° C. with 50 g of reference puffed rice. The temperature of 40° C. was selected because it is the maximum sustainable temperature in animal feeding. A second mixture was also prepared, named as “mixture B”, by mixing 250 ml of drinking water at a temperature of 40° C. with 50 g of sample puffed rice. Mixture A and mixture B were put separately under magnetic stirring, maintaining the temperature of the water at 40° C. with a thermostatic bath.

The water percentage content (humidity %) in the grains of rice was determined by thermogravimetric analysis with a thermobalance of known type (Sartorius MA45) and setting the achievement of constant weight as an end-of-analysis criterion. For each of the two mixtures, the weight measurement was carried out by taking an amount of mixture at 0 minutes, 1 minute, 2 minutes, 3 minutes, 5 minutes, 7 minutes and 10 minutes from the addition of water (namely from the preparation of the mixture). The mixture samples taken at 0, 1, 2, 3, 5, 7, 10 minutes were filtered (to separate the grains of rice from the water phase), dried with absorbent paper and weighed (1 g of material).

The results of the performed thermogravimetric analysis are reported in the following Table 5, in which the reported values express the w/w percentage of weight loss, corresponding to the absorbed humidity:

TABLE 5

| Time | Sample | Reference |
|---|---|---|
| (minutes) | puffed rice | puffed rice |
| 0 | 7.64 | 9.18 |
| 1 | 66.53 | 77.05 |
| 2 | 70.69 | 77.86 |
| 3 | 72.96 | 79.56 |
| 5 | 74.84 | 78.85 |
| 7 | 74.16 | 79.22 |
| 10 | 73.35 | 78.26 |

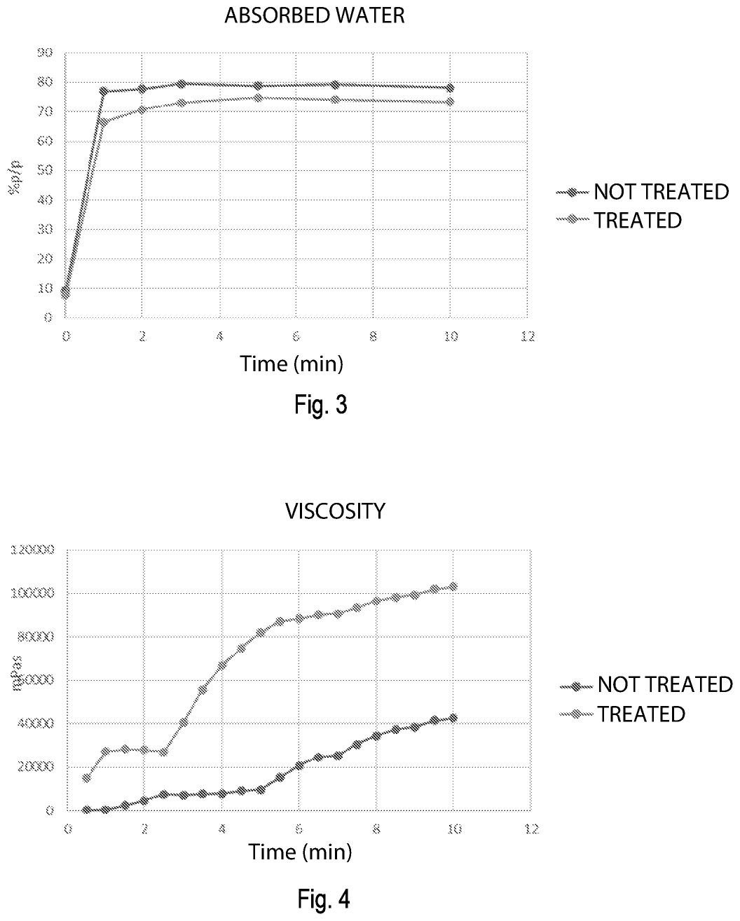

The results of the performed thermogravimetric analysis are also reported in the scatter graph of FIG. 3, showing the water absorption curves of the sample puffed rice and of the reference puffed rice.

The obtained results show that the sample puffed rice has consistently a water absorption capacity that is substantially less than the reference puffed rice. A statistical analysis of the obtained results was carried out (variance analysis or ANOVA), excluding the values measured on the amounts taken at 0 minutes, and the aforesaid analysis has confirmed that the two groups of values (sample; reference) are not superimposable, with 95% significance.

### Example 14—Measurement of the Viscosity Profile (Rheometric Analysis) in Samples of Non-Treated Puffed Rice and of Puffed Rice Treated with the Method According to the Invention

Samples were tested of puffed rice treated with the method according to the invention, named hereinafter as “puffed rice sample”, and samples of puffed rice not treated with the method according to the invention, named hereinafter as “reference puffed rice”.

A first mixture was prepared, named “mixture A”, by mixing 250 ml of drinking water at a temperature of 40° C. with 50 g of reference puffed rice. The temperature of 40° C. was selected because it is the maximum sustainable temperature in animal feeding. A second mixture was also prepared, named as “mixture B”, by mixing 250 ml of drinking water at a temperature of 40° C. with 50 g of sample puffed rice. Mixture A and mixture B were put separately under magnetic stirring, maintaining the temperature of the water at 40° C. by a heating plate. Every 30 seconds, a viscosity measurement (rheometric analysis) was carried out, by using a viscometer of known type (Brookfield viscometer RVDVE model, equipped with an RV04 impeller) with a rotation speed of 2 rpm.

The results of the performed rheometric analysis are reported in the following Table 6, in which the reported values are expressed in millipascal per second (mPa-s):

TABLE 6

| Time | Sample | Reference |
|---|---|---|
| (minutes) | puffed rice | puffed rice |
| 0.5 | 14900 | 450 |
| 1 | 27300 | 500 |
| 1.5 | 28300 | 2600 |
| 2 | 28000 | 4900 |
| 2.5 | 27200 | 7600 |
| 3 | 40400 | 7300 |
| 3.5 | 55800 | 7800 |
| 4 | 66600 | 8100 |
| 4.5 | 74900 | 9200 |
| 5 | 81800 | 9800 |
| 5.5 | 86900 | 15200 |
| 6 | 88200 | 20800 |
| 6.5 | 89900 | 24600 |
| 7 | 90500 | 25400 |
| 7.5 | 93100 | 30600 |
| 8 | 96400 | 34500 |
| 8.5 | 98200 | 37300 |
| 9 | 99200 | 38500 |
| 9.5 | 102000 | 41500 |
| 10 | 103000 | 42500 |

The results of the performed rheometric analysis are also reported in the scatter graph of FIG. 4, showing the variation curves of the viscosity of the sample puffed rice and of the reference puffed rice.

The obtained results enable two distinct trends to be highlighted.

The reference puffed rice shows a sudden increase in viscosity (from 7300 to 7800) at the third minute, which is explainable by the fact that the grains of rice, by absorbing water, lose their own floating capacity and make the mixture more viscous. The increase in viscosity then continues with a logarithmic trend.

The sample puffed rice, on the contrary, shows lower viscosity values and has a linear trend. The mixture is homogenized (through the effect of the water absorption) in a slow and constant manner, this highlighting the fact that the thickening effect in the rice grains treated with the method according to the invention is significantly less than the thickening effect in the non-treated rice grains.

In brief, Examples 13 and 14 clearly show that grains of rice provided with the edible hydrophobic shell, obtained through the method according to the invention, display a shielding effect against water (water at a temperature equal to 40° C.) in comparison with grains of rice free of the aforesaid shell.

From what has been previously disclosed and exemplified, it can be stated that the method and the food product according to the invention enable the drawbacks of the prior art to be overcome effectively and multiple advances to be obtained.

Variations on and/or additions to what has been disclosed above are possible. For example, although the previously disclosed compositions were prepared on a laboratory scale, the person skilled in the art is able to select and apply preparation procedures that are suitable for a production on industrial scale.

1. An instant food composition for animals, said composition being reconstitutable by adding water and comprising:
a dehydrated vegetable component selected from the group consisting of cereal grains, quinoa grains, buckwheat grains and mixtures thereof, wherein said grains are dehydrated and the outer surface of said grains is at least partially coated with an edible hydrophobic shell whereby said cereal grains have an increased rehydration time when said food composition is reconstituted with water;
a dehydrated protein component of animal origin;
an additional dehydrated vegetable component, said additional dehydrated vegetable component being different from said cereals, said quinoa and said buckwheat;
a dehydrated appetizing component.

2. The composition according to claim 1, wherein said cereals comprise rice.

3. The composition according to claim 1, wherein said dehydrated grains are selected from the group consisting of: extruded grains, puffed grains and flaked grains.

4. The composition according to claim 1, having the following formulation by weight %:

| | |
|---|---|
| Dehydrated vegetable component | 68-97.9% |
| Dehydrated protein component of animal origin | 1-14% |
| Additional dehydrated vegetable component | 1-14% |
| Dehydrated appetizing component | 0.1-5% |

5. The composition according to claim 1, further comprising a functional component.

6. The composition according to claim 5, having the following formulation by weight %:

| | |
|---|---|
| Dehydrated vegetable component | 63-97.8% |
| Dehydrated protein component of animal origin | 1-14% |
| Additional dehydrated vegetable component | 1-14% |
| Dehydrated appetizing component | 0.1-5% |
| Functional component | 0.1-5 |

7. The composition according to claim 1, wherein said edible hydrophobic shell comprises an oil component, a thickening component, a dehydrated appetizing component, an emulsifying component and a liposoluble antioxidant component.

8. The composition according to claim 7, wherein said edible hydrophobic shell has the following formulation by weight %:

| | |
|---|---|
| Oil component | 90-99.2% |
| Thickening component | 0.5-5% |
| Dehydrated appetizing component | 0.1-3% |
| Emulsifying component | 0.1-1% |
| Liposoluble antioxidant component | 0.1-1% |

9. The composition according to claim 1, wherein said dehydrated protein component of animal origin is selected from the group consisting of: flours of animal origin, dried or freeze-dried products of animal origin and dehydrated meat.

10. The composition according to claim 1, wherein said additional dehydrated vegetable component is selected from the group consisting of: dried vegetables in pieces, dried fruit in pieces and freeze-dried vegetables.

11. The composition according to claim 1, wherein said dehydrated appetizing component is selected from the group consisting of: mixture of dehydrated yeasts, hydrolyzed animal proteins of poultry origin, synthetic flavouring molecules and mixtures thereof.

12. The composition according to claim 5, wherein said functional component is selected from the group consisting of: sodium, potassium, calcium, magnesium, manganese, zinc, copper, Boswellia serrata extract, willow extract, turmeric extract, Ginkgo biloba extract, blueberry extract, hyaluronic acid, chondroitin sulphate, glucosamine, collagen, methylsulfonylmethane, vitamin A, vitamin C, vitamin D, vitamins B1-B5, vitamin B6, vitamin B9, vitamin B12, biotin, folic acid, methionine, taurine, pectin, bentonite and mixtures thereof.

13. The composition according to claim 7, wherein said oil component of said edible hydrophobic shell is selected from the group consisting of: oil of vegetable origin, oil of animal origin and mixtures thereof.

14. The composition according to claim 7, wherein said thickening component of said edible hydrophobic shell is selected from the group consisting of: monoglycerides of fatty acids of vegetable origin, diglycerides of fatty acids of vegetable origin, triglycerides of fatty acids of vegetable origin, magnesium stearate, glyceryl stearate, vegetable waxes, butter of vegetable origin, animal fats and mixtures thereof.

15. The composition according to claim 7, wherein said dehydrated appetizing component of said dehydrated edible hydrophobic shell is selected from the group consisting of: mixture of dehydrated yeasts, hydrolyzed animal proteins of poultry origin, synthetic flavouring molecules and mixtures thereof.

16. The composition according to claim 7, wherein said emulsifying component of said edible hydrophobic shell comprises soy lecithin.

17. The composition according to claim 7, wherein said liposoluble antioxidant component of said edible hydrophobic shell is selected from the group consisting of: tocopherols, rosemary extracts and mixtures thereof.

18. The composition according to claim 1, wherein said dehydrated vegetable component is further mixed with a flour selected from the group consisting of: cereal flour, quinoa flour, buckwheat flour and mixtures thereof.

19. The composition according to claim 1, wherein said edible hydrophobic shell has a thickness that is comprised between 20 μm and 500 μm.

20. Method A method for preparing an instant food composition for animals, said method comprising the following steps:
mixing a plurality of dehydrated grains of a vegetable component that is selected from the group consisting of cereals, quinoa, buckwheat and mixtures thereof, so as to obtain a mixture of said grains;
during said mixing, spraying an edible hydrophobic composition at a temperature of 40° C. onto said mixture of said grains;
allowing said edible hydrophobic composition to deposit on an outer surface of said grains;
allowing said deposited hydrophobic composition to cool down to ambient temperature and solidify on said outer surface of said grains, so as to form an edible hydrophobic shell which at least partially coats said grains whereby said cereal grains have an increased rehydration time when said food composition is reconstituted with water;
further mixing said grains that are coated with said edible hydrophobic shell with a dehydrated protein component of animal origin, an additional dehydrated vegetable component, said additional dehydrated vegetable component being different from said cereals, said quinoa and said buckwheat, and a dehydrated appetizing component, so as to obtain said instant food composition for animals.

21. The method according to claim 20, wherein said cereals comprise rice.

22. The method according to claim 20, wherein said dehydrated grains are selected from the group consisting of: extruded grains, puffed grains and flaked grains.

23. The method according to claim 20, further comprising preparing said edible hydrophobic composition, wherein said preparing said edible hydrophobic composition comprises:
dispersing a thickening component at a temperature comprised between 40° C. and 50° C. in an oil component;
adding under mixing a dehydrated appetizing component, an emulsifying component and a liposoluble antioxidant component;
mixing reciprocally said thickening component, said dehydrated appetizing component, said emulsifying component and said liposoluble antioxidant component until a homogeneous mixture is obtained.

24. The method according to claim 23, wherein said preparing said edible hydrophobic composition is performed before said mixing said plurality of dehydrated grains.

25. The method according to claim 20, wherein, in said further mixing, a functional component is added.

26. The method according to claim 20, wherein said plurality of dehydrated grains of said vegetable component is mixed with a flour selected from the group consisting of: cereal flour, quinoa flour, buckwheat flour and mixtures thereof.

27. The method according to claim 20, further comprising inserting said instant food composition inside a container and closing said container by applying a pressure cap or a peelable closure film.

28. The method according to claim 27, wherein said inserting comprises inserting an amount of said instant food composition comprised between 20 grams and 250 grams.

29. The method according to claim 27, further comprising opening said container at the time of use and pouring water into said container until reaching a level indicator that is comprised in said container, so as to reconstitute said instant food composition for animals.

30. The method according to claim 29, wherein said water is water at ambient temperature or lukewarm water, said lukewarm water having a maximum temperature of 40° C.
